(19) United States
(12) Patent Application Publication
(10) Pub. No.: US 2021/0260500 A1
(43) Pub. Date: Aug. 26, 2021

(54) Continuous Flow System For Draining Fuel-Water Separator

(71) Applicant: Progress Rail Locomotive Inc., LaGrange, IL (US)

(72) Inventors: Michael B. Goetzke, Orland Park, IL (US); Vinay Hasija, Chicago, IL (US); Nikhil Chakravarthy Sangam, Chicago, IL (US)

(73) Assignee: Progress Rail Locomotive Inc., LaGrange, IL (US)

(21) Appl. No.: 16/796,604

(22) Filed: Feb. 20, 2020

(51) Int. Cl. B01D 17/12; B01D 17/02; F02M 37/24; F02M 37/00

(52) U.S. Cl. CPC B01D 17/12; B01D 17/02; F02M 37/007; F02M 37/0052; F02M 37/24

(57) ABSTRACT

A continuous flow system for draining a fuel-water separator is disclosed. The fuel water separator is configured to separate water from fuel in a fluid received by the fuel-water separator and to output a first separated liquid that comprises water. The continuous flow system may comprise a return conduit fluidly connecting the fuel-water separator to a fuel tank. The return conduit may be configured to deliver the first separated liquid received from the fuel-water separator to the fuel tank. The fuel-water separator is in continuous fluid communication with the fuel tank through the return conduit.

### TECHNICAL FIELD

The present disclosure generally relates to water drainage from fuel systems of a machine, and more particularly, to fuel systems of locomotives.

### BACKGROUND

In fuel systems, such as those on locomotive engines, water is removed from the fuel supplied to engines in order to reduce the risk of corrosion and reduced performance of the engine and its related components. Fuel-water separators are typically used to remove water from the fuel prior to delivery to the engine. The liquid (primarily water) that has been separated out from the fuel by the fuel-water separator generally accumulates in the fuel-water separator and, at some point, is released and directed into a waste tank. Such release of such liquid from the fuel-water separator is typically controlled by a sensor and a magnetic valve. The sensor activates when such liquid reaches a certain level in the fuel-water separator and triggers the magnetic valve to open to release the accumulated liquid out of the fuel-water separator for routing to the waste tank for subsequent disposal. Alternatively, a manual drain cap may be utilized.

Ideally, the liquid separated and released into the waste tank comprises only water. However, while such liquid primarily includes water, the liquid may also include, and often does, some amount of fuel. This leads to a loss of fuel to the fuel system. Also, with time and use the magnetic valve can become stuck/frozen in the open or closed position. When stuck in the open position, a drop in pressure is experienced in the fuel-water separator, which can result in a pressure drop in the common rail fuel system that delivers fuel to the engine. Such a drop in pressure may adversely effect engine performance. When stuck in the closed position, the accumulated water is not released and may back up within the fuel-water separator, adversely effecting performance. Eventually, fuel mixed with water may reach the engine and its components. Similar problems may be experienced with the manually operated drain cap because such drain cap over time and use may become stuck in the closed position.

U.S. Pat No. 7,655,140, issued Feb. 2, 2010, discloses a fuel-water separator system that includes a fuel tank for storing fuel and a fuel-water separator fluidly coupled to the fuel tank fir separating water from the fuel. The fuel pump has a suction side that is fluidly coupled to the fuel-water separator for pumping fuel from the fuel-water separator. The fuel pump has a high pressure side where the fuel has a higher pressure than at the suction side. A water pump, such as a venturi or a jet pump, is fluidly coupled between the fuel-water separator and the fuel tank for pumping the water from the fuel water separator into the fuel tank. The water pump is fluidly coupled to the high pressure side of the fuel pump to receive the fuel at the higher pressure to drive the water pump. While beneficial, a better system is needed.

### SUMMARY OF THE DISCLOSURE

In one aspect of the present disclosure, a continuous flow system for draining a fuel-water separator is provided. The fuel-water separator is configured to separate water from fuel in a fluid received by the fuel-water separator and to output a first separated liquid that comprises water. The system may comprise a return conduit fluidly connecting the fuel-water separator to a fuel tank. The return conduit may be configured to deliver the first separated liquid received from the fuel-water separator to the fuel tank. The fuel-water separator is in continuous fluid communication with the fuel tank through the return conduit.

In another aspect of the disclosure, a method for assembling a continuous flow system for draining a fuel-water separator on a locomotive is disclosed. The method may comprise coupling a fuel-water separator to a fuel tank of the locomotive with conduit, the fuel-water separator in continuous fluid communication with the fuel tank through the return conduit. The fuel-water separator is configured (a) to separate water from fuel in a fluid received by the fuel-water separator and (b) to output a first separated liquid that comprises water. The return conduit is configured to deliver the first separated liquid received from the fuel-water separator to the fuel tank.

In yet another aspect of the disclosure, a continuous flow system for draining a fuel-water separator disposed on a locomotive is disclosed. The locomotive includes a fuel tank and the fuel-water separator. The fuel-water separator has an input port, a drain port and an output port. The fuel-water separator is configured to separate water from fuel in a fluid received by the fuel-water separator through the input port and to output through the drain port a first separated liquid that comprises water, and to output through the output port a second separated liquid that comprises fuel. The continuous flow system may comprise a return conduit fluidly connecting the drain port of the fuel-water separator to the fuel tank of the locomotive. The return conduit is configured to deliver the first separated liquid received from the fuel-water separator to the fuel tank, the fuel-water separator in continuous fluid communication with the fuel tank through the return conduit.

### BRIEF DESCRIPTION OF THE DRAWINGS

FIG. 1 is a diagrammatic view of an exemplary machine that includes the features disclosed herein;

FIG. 2 is a schematic illustration of an exemplary fuel system for the exemplary machine of FIG. 1; and

FIG. 3 is a schematic illustration of an exemplary continuous flow system for draining a fuel-water separator of the fuel system of FIG. 2.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts, unless otherwise specified.

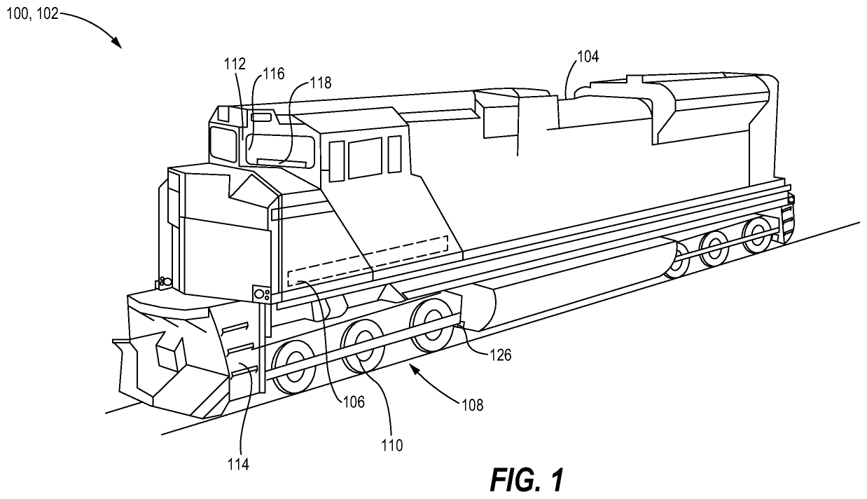

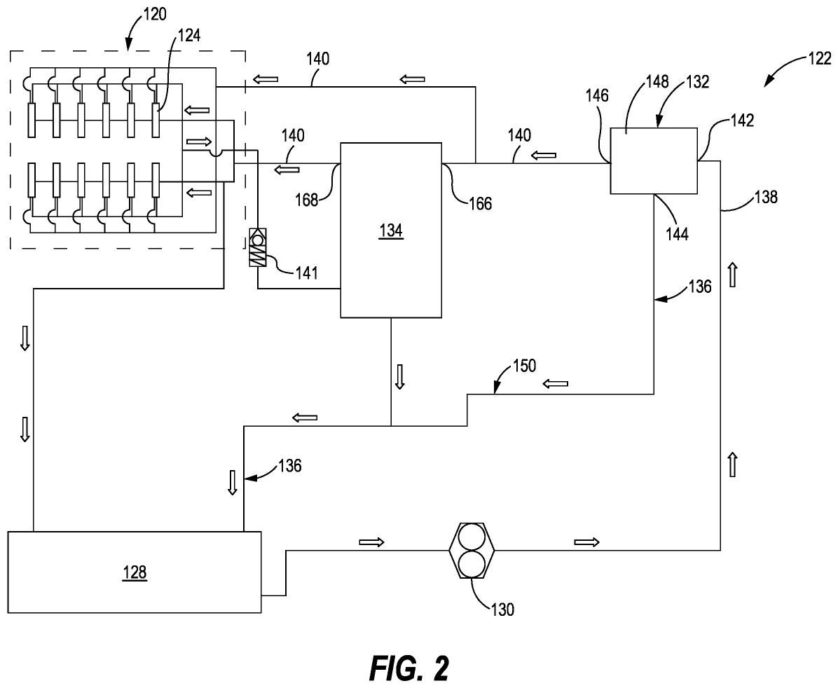

FIG. 1 illustrates one example of a machine 100 that incorporates the features of the present disclosure. The exemplary machine 100 may be a locomotive 102, although the features disclosed herein may be utilized with other types of machines 100. As illustrated in FIG. 1, the locomotive 102 may include a frame 104, a power system 106 mounted to the frame 104, a brake system 108, and a wheel assembly 110 in operable communication with the power system 106 and the brake system 108. The frame 104 may include a cab assembly 112, and one or more access structures 114 such as stairs, or the like. The cab assembly 112 may define an operator compartment 116 containing a plurality of control devices 118 such as throttle hands, controls or other types of display and input devices that control or monitor the operation of the locomotive 102. The power system 106 may include an engine 120 (see FIG. 2), a fuel system 122 (see FIG. 2) and a drive system (not shown). The engine 120 includes fuel injectors 124 and a combustion chamber (not shown) and is configured to generate and to provide power to operate the locomotive 102 (FIG. 1) and the drive system (not shown). The engine 120 (FIG. 2) may embody an internal combustion engine such as, for example, a diesel engine, a gasoline engine, a gaseous fuel powered engine, or the like. The drive system (not shown) is configured to propel the locomotive 102 (FIG. 1) by driving the wheel assembly 110. The brake system 108 includes one or more brakes 126 and may be any appropriate brake system 108 configured to release or apply braking force to the wheel assembly 110. When braking force is applied, movement of the wheel assembly 110 is retarded or prevented by application of the brakes 126 to the wheel assembly 110.

FIG. 2 illustrates an exemplary fuel system 122 for the locomotive 102 of FIG. 1. The fuel system 122 is fluidly connected to the engine 120 and is configured to deliver fuel to the fuel injectors 124 of the engine 120. The fuel system 122 may include a fuel tank 128, a fuel pump 130, a fuel-water separator 132, a high pressure common rail pump 134, and a continuous flow system 136 for draining the fuel-water separator 132. The fuel-water separator 132 may be in fluid communication with an input fuel line 138 configured to deliver fluid from the fuel tank 128 to the fuel-water separator 32. An output fuel line 140 may fluidly connect the fuel-water separator 132 to the engine 120 and its fuel injectors 124.

The fuel tank 128 is configured to hold fuel and is in fluid communication with the fuel-water separator 132. A fuel pump 130 is fluidly connected to the fuel tank 128 and an input port 142 of the fuel-water separator 132. The fuel pump 130 is configured to pump fluid out of the fuel tank 128 to deliver such fluid to the input port 142 of the fuel-water separator 132 via the input fuel line 138. The fluid pumped out of the fuel tank 128 comprises fuel, but often may comprise fuel and some volume of water.

The fuel-water separator 132 may include the input port 142, a drain port 144 and an output port 146 disposed in a body 148. As is known in the art, the fuel-water separator 132 is configured to separate water from fuel in a fluid received by the fuel-water separator 132 through the input port 142. The fuel-water separator 132 is further configured to provide through the drain port 144 a first separated liquid that comprises water, and to provide through the output port 146 a second separated liquid that comprises fuel.

The high pressure common rail pump 134 includes an inflow fuel port 166 and an outflow fuel port 168. The inflow fuel port 166 of the high pressure common rail pump 134 is fluidly connected to the output port 146 of the fuel-water separator 132. The outflow fuel port 168 of the high pressure common rail pump 134 is fluidly connected to the fuel injectors 124 of the engine 120. The high pressure common rail pump 134 is configured to suction under high pressure the second separated liquid (that comprises fuel) out of the output port 146 and deliver such second separated liquid to the fuel injectors 124 of the engine 120.

The continuous flow system 136 for draining the fuel-water separator 132 includes a return conduit 150 fluidly connecting the drain port 144 of the fuel-water separator 132 to the fuel tank 128. The return conduit 150 is configured to continuously deliver the first separated liquid (that comprises water) received from the fuel-water separator 132 to the fuel tank 128 such that the fuel-water separator 132 is in continuous fluid communication with the fuel tank 128 through the return conduit 150. For example, during operation of the fuel-water separator 132, the return conduit 150 is configured to provide a continuous flow of the first separated liquid from the fuel-water separator 132 to the fuel tank 128.

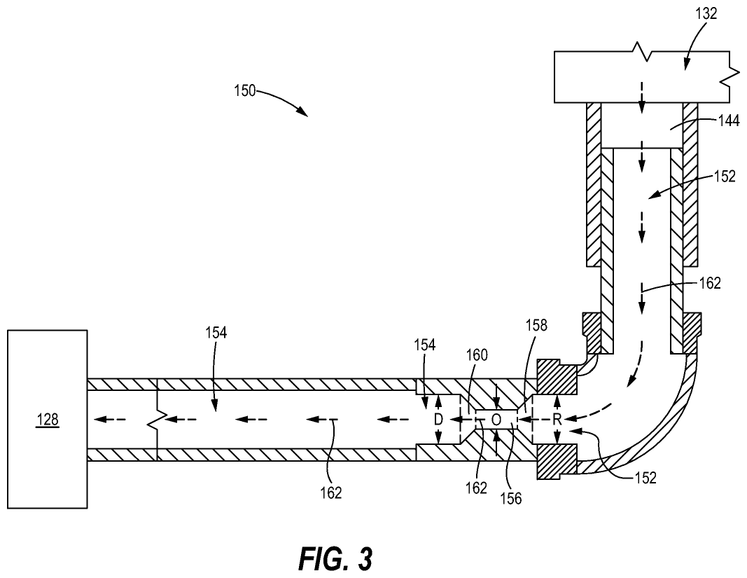

Turning now to FIG. 3, the return conduit 150 includes a receiving conduit 152, a delivering conduit 154 and an orifice 156 disposed between the receiving conduit 152 and the delivering conduit 154.

The receiving conduit 152 has a receiving diameter R. The receiving diameter R may vary along the length of the receiving conduit 152. The receiving conduit 152 includes a receiving transition portion 158 disposed adjacent to the orifice 156. The receiving transition portion 158 may, in some embodiments, be frustoconical in shape. As used herein, the receiving diameter R is measured for the receiving conduit 152 at a point outside of the receiving transition portion 158 since, in some embodiments, the receiving transition portion 158 may narrow to the same diameter as the orifice diameter O in the area near where the receiving transition portion 158 meets or is adjacent to the orifice 156.

The delivering conduit 154 has a delivering diameter D. The delivering diameter D may vary along the length of the delivering conduit 154. The delivering conduit 154 includes a delivering transition portion 160 disposed adjacent to the orifice 156. The delivering transition portion 160 may, in some embodiments, be frustoconical in shape. As used herein, the delivering diameter D is measured for the delivering conduit 154 at a point outside of the delivering transition portion 160 since, in some embodiments, the delivering transition portion 160 may narrow to the same diameter as the orifice diameter O in the area near where the delivering transition portion 160 meets or is adjacent to the orifice 156.

The orifice 156 has an orifice diameter O that is less than the receiving diameter R. The orifice diameter O may also be less than the delivering diameter D. In some embodiments, such as the embodiment shown in FIG. 3, the orifice 156 may be elongated and cylindrical in shape. The orifice 156 is configured to provide a continuous flow of the first separated liquid to the delivering conduit 154. The continuous flow may he a continuous drip. For example, in one embodiment, the orifice diameter O may be in the range of about 0.10 cm (about 0.04 inches) to about 0.20 cm (about 0.08 inches).

In an embodiment, the orifice 156 may he so dimensioned so that the continuous flow of the first separated liquid out of the fuel-water separator 132 does not result in a pressure drop of more than 0.8% in the second separated liquid (that comprises fuel) delivered to the fuel system 122, as measured before (and proximal to) the inflow fuel port 166 (see FIG. 2) of the high pressure common rail pump 134. Said another way, the orifice diameter O may be dimensioned so as to provide a continuous flow or dripping of the first separated liquid (delivered by the orifice 156) into the delivering conduit 154 that results in 0-0.8% pressure drop in the second separated liquid, as measured before (and proximal to) the inflow fuel port 166 of the high pressure common rail pump 134.

The return conduit 150 defines a flow path 162 for the first separated fluid extending from the (open) drain port 144 of the fuel-water separator 132 to the fuel tank 128. The flow path 162 is free from obstruction, meaning that the flow path 162 is configured so that the first separated fluid flowing out of the fuel-water separator 132 through the return conduit 150 is not blocked from flowing (e.g., not blocked by a valve that is closed or a drain cap disposed over the drain port 144); in other words the flow path 162 of the first separated fluid in the return conduit 150 is free from obstruction by a valve, drain cap or the like).

Also disclosed is a method for assembling a continuous flow system 136 for draining a fuel-water separator 132 on a locomotive 102. The method may comprise coupling a fuel-water separator 132 to a fuel tank 128 of the locomotive 102 with a return conduit 150, the fuel-water separator 132 in continuous fluid communication with the fuel tank 128 through the return conduit 150, wherein the fuel-water separator 132 is configured (a) to separate water from fuel in a fluid received by the fuel-water separator 132 and (b) to output a first separated liquid that comprises water, wherein the return conduit 150 is configured to deliver the first separated liquid received from the fuel-water separator 132 to the fuel tank 128.

### INDUSTRIAL APPLICABILITY

In operation, the fuel-water separator 132 receives fluid at the input port 142. The fluid includes fuel and may further include water. The fuel-water separator 132 separates the fluid into a first separated liquid that comprises water and a second separated liquid that comprises fuel (or is fuel). The second separated liquid exits the fuel-water separator 132 via the output port 146 and is pumped, for example, by the high pressure common rail pump 134, to the fuel injectors 124 of the engine 120 of, for example, a locomotive 102. The first separated liquid exits the fuel-water separator 132 via the drain port 144 and flows into and through the return conduit 150 to the fuel tank 128 in a continuous flow or dripping flow. The return conduit 150, as discussed herein, includes a receiving conduit 152, a delivering conduit 154, and an orifice 156. The orifice 156 is so dimensioned as (a) to provide continuous flow or dripping of the first separated liquid (delivered by the orifice 156) into the delivering conduit 154 and (b) to maintain a substantially constant pressure at the inflow fuel port 166 of the high pressure common rail pump 134 or result in a variance of 0-0.8% pressure drop during operation of the fuel-water separator 132 (as measured at the inflow fuel port 166 of the high pressure common rail pump 134).

In general, the foregoing disclosure finds utility in various applications relating to draining of the first separated liquid (that comprises water) from fuel-water separators 132. More specifically, the disclosed continuous flow system 136 may be used to drain fuel-water separators 132 of locomotives 102 or the like without an adverse effect on the pressure of the second separated liquid (that comprises fuel) provided at the inflow fuel port 166 of the high pressure common rail pump 134. This reduces the maintenance and adverse effects of traditional systems (for controlling the discharge of separated fluid comprising water from fuel-water separators 132), which have valves, drain caps or the like that become stuck/frozen in an open or closed position. When such valves or drain caps are frozen in a closed position, damage to the fuel system 122 and its components may occur. When stuck in the open position, the fuel system 122 and engine 120 may become inefficient or experience loss in power.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

1. A continuous flow system for draining a fuel-water separator that is in fluid communication with an inflow fuel port of a high pressure common rail pump, the fuel-water separator configured to separate water from fuel in a fluid received by the fuel-water separator and to output through a drain port a first separated liquid that comprises water and to output through an output port a second separated liquid that comprises fuel, the continuous flow system comprising:
a return conduit fluidly connecting the fuel-water separator to a fuel tank, the return conduit configured to deliver the first separated liquid received from the drain port of the fuel-water separator to the fuel tank, the fuel-water separator in continuous fluid communication with the fuel tank through the return conduit, the return conduit including a receiving conduit coupled to the drain port, a delivering conduit coupled to the fuel tank and an orifice disposed between the receiving conduit and the delivering conduit, the receiving conduit includes a receiving transition portion disposed adjacent to the orifice, the drain port of the fuel-water separator disposed upstream of the receiving transition portion, the orifice having an orifice diameter, the receiving conduit having a receiving diameter, the delivering conduit having a delivering diameter, the orifice diameter less than the receiving diameter and less than the delivering diameter, the orifice configured to provide during operation of the fuel-water separator a continuous drip of the first separated liquid into the delivering conduit and a pressure drop of 0-0.8% in the second separated liquid at the inflow fuel port of the high pressure common rail pump.

2. (canceled)

3. The continuous flow system of claim 1, in which the orifice diameter is 0.10 cm to 0.20 cm.

4. (canceled)

5. The continuous flow system of claim 1, wherein the return conduit defines a flow path, the flow path free from obstruction and the pressure drop is 0% in the second separated liquid at the inflow fuel port of the high pressure common rail pump.

6. The continuous flow system of claim 1, wherein the return conduit defines a flow path, the flow path free from obstruction by a valve.

7. The continuous flow system of claim 1, wherein the return conduit is configured to continuously deliver the first separated liquid to the fuel tank during operation of the fuel-water separator.

8. The continuous flow system of claim 1, in which the receiving transition portion frustoconical in shape.

9. The continuous flow system of claim 1, in which the delivering conduit includes a delivering transition portion disposed adjacent to the orifice, the delivering transition portion frustoconical in shape.

10. A method of assembling a continuous flow system for draining a fuel-water separator on a locomotive, the fuel-water separator including an input port, a drain port and an output port, the method comprising:
coupling the drain port of the fuel-water separator to a fuel tank of the locomotive with a return conduit, the fuel-water separator in continuous fluid communication with the fuel tank through the return conduit, the return conduit including a receiving conduit coupled to the drain port, a delivering conduit coupled to the fuel tank and an orifice disposed between the receiving conduit and the delivering conduit, the orifice having an orifice diameter, the receiving conduit having a receiving diameter, the delivering conduit having a delivering diameter, the orifice diameter less than the receiving diameter and less than the delivering diameter;
coupling the output port of the fuel-water separator to an inflow fuel port of a high pressure common rail pump,
wherein the fuel-water separator is configured (a) to separate water from fuel in a fluid received by the input port of the fuel-water separator and (b) to output through the drain port a first separated liquid that comprises water and to output through the output port a second separated liquid that comprises fuel,
wherein the return conduit is configured to deliver the first separated liquid received from the fuel-water separator to the fuel tank
wherein the orifice is configured to provide during operation of the fuel-water separator a continuous drip of the first separated liquid into the delivering conduit and a pressure drop of 0-0.8% in the second separated liquid at the inflow fuel port of the high pressure common rail pump,
wherein the return conduit is configured to define a flow path free from obstruction during use of the continuous flow system.

11. The method according to claim 10, in which the receiving conduit includes a receiving transition portion disposed adjacent to the orifice, the receiving transition portion frustoconical in shape, wherein the drain port of the fuel-water separator is disposed upstream of the receiving transition portion.

12. The method according to claim 11, wherein the orifice diameter is 0.10 cm to 0.20 cm.

13. (canceled)

14. The method according to claim 10, wherein the return conduit defines a flow path that is free from obstruction and the pressure drop is 0% in the second separated liquid at the inflow fuel port of the high pressure common rail pump.

15. A continuous flow system for draining a fuel-water separator disposed on a locomotive, the locomotive including a fuel tank and the fuel-water separator, the fuel-water separator having an input port, a drain port and an output port, the fuel-water separator configured to separate water from fuel in a fluid received by the fuel-water separator through the input port and to output through the drain port a first separated liquid that comprises water, and to output through the output port a second separated liquid that comprises fuel, the continuous flow system comprising:
a return conduit fluidly connecting the drain port of the fuel-water separator to the fuel tank of the locomotive, the return conduit configured to deliver the first separated liquid received from the drain port of the fuel-water separator to the fuel tank, the fuel-water separator in continuous fluid communication with the fuel tank through the return conduit, the return conduit including a receiving conduit coupled to the drain port, a delivering conduit coupled to the fuel tank and an orifice disposed between the receiving conduit and the delivering conduit, the receiving conduit including a receiving transition portion disposed adjacent to the orifice, the receiving transition portion frustoconical in shape, the drain port disposed upstream of the receiving transition portion, the orifice having an orifice diameter of 0.10 cm to 0.20 cm, the receiving conduit having a receiving diameter, the delivering conduit having a delivering diameter, the orifice diameter less than the receiving diameter and less than the delivering diameter, the orifice configured to provide during operation of the fuel-water separator a continuous drip of the first separated liquid into the delivering conduit and a pressure drop of 0-0.8% in the second separated liquid at the inflow fuel port of the high pressure common rail pump, wherein the return conduit is configured to define a flow path free from obstruction during use of the continuous flow system.

16. (canceled)

17. The continuous flow system according to claim 15, wherein the orifice is cylindrical in shape.

18. (canceled)

19. (canceled)

20. The continuous flow system according to claim 15, wherein the orifice is configured to provide a continuous drip of the first separated liquid to the fuel tank.
